(19) United States
(12) Patent Application Publication
(10) Pub. No.: US 2004/0062630 A1
(43) Pub. Date: Apr. 1, 2004

(54) Systems and methods for handling aircraft munitions

(76) Inventor: Lou Marrero, Woodbridge, VA (US)

Correspondence Address: JEFFREY S. WHITTLE, BRACEWELL & PATTERSON, P.O. BOX 61389, HOUSTON, TX, 77208-1389, US

(21) Appl. No.: 10/261,115

(22) Filed: Sep. 30, 2002

(51) Int. Cl. B66F 1/00

(52) U.S. Cl. 414/589

(57) ABSTRACT

An aircraft munitions handling apparatus and method are provided. The apparatus has a set of wheel assemblies that can be independently driven and can be omni-directional to allow the apparatus to move in any longitudinal, lateral, or diagonal direction for excellent maneuverability. The apparatus also has a base and an elevator extending from the base. The elevator can use a double-parallelogram, cantilevered arm configuration that folds nearly flat to fit within a profile of the base. A portion of the arm rotates forward to place a munitions support in front of the base when remote reach is required. A pivot assembly having four movable cams at the four corners of the munitions support are used as a self-leveling device for unstable conditions, or to pitch and roll the munitions support as needed to attach munitions to an aircraft. In addition, the munitions handling apparatus is capable of passing beneath objects having very limited vertical clearances.

### BACKGROUND OF THE INVENTION

1. Field of the Invention

J The present invention relates in general to the munitions handling industry and, in particular, to an apparatus, system, and method for making munitions highly maneuverable during transporting, loading, and unloading.

2. Description of the Related Art

In the prior art, various munitions handling equipment has been developed for loading and unloading munitions, armaments, and other payloads onto and off of aircraft. Such systems conventionally provide a trailer-type apparatus that is towed behind a truck or tractor. After a munition is placed on the trailer-type apparatus, the truck or tractor tows the apparatus to an aircraft where the apparatus is positioned beneath a location on the aircraft such that the munition can be elevated into a loading position for attachment to the location on the aircraft. Examples of such a system can be seen in U.S. Pat. Nos. 5,083,892 and 4,522,548 by Oswald, et al., each titled “Aerial Weapons Handling Trailer,” U.S. Pat. No. 4,526,344 by Oswald et al., titled “Auxiliary Lift Adapter,” U.S. Pat. No. 3,642,250 to Klopp entitled “Bomblift Trailer Lifting Mechanism,” U.S. Pat. No. 2,822,931 by Sparrow titled “Device for Loading Bombs and the Like,” and U.S. Pat. No. 2,785,807 by Prowinsky titled “Straight Line Lift Truck.”

Although some of these conventional aircraft munitions handling systems are capable of lifting heavy munitions payloads, the present inventor has recognized that the maneuverability of these systems is quite limited. Almost all of these prior art systems utilize trailers having conventional wheel assemblies that are less maneuverable than the truck or tractor that is pulling the trailer, thus making lateral movement of the trailer virtually impossible. The truck or tractor must be carefully repositioned in a trial-and-error process to precisely locate the trailer with respect to the aircraft being loaded. Some of the Oswald et al. patents referenced above contemplate additional steerage for the wheel assemblies, but even these systems fail to provide the capability to quickly and accurately move payloads weighing thousands of pounds a few inches in any direction. Moreover, all of these prior art systems are designed to provide merely vertical lift of a payload once the trailer is in position beneath the aircraft. These systems are not designed to provide fine articulation of a payload in any direction once the payload is elevated above the trailer without relocation of the trailer itself

There are other prior art systems that are not specifically designed for handling aircraft munitions, but do provide other types of devices for elevating or lifting payloads. Examples of such an apparatus can be seen in U.S. Pat. No. 4,130,178 by Smith, Jr. titled “Elevating Device,” U.S. Pat. No. 4,070,807 by Smith, Jr. titled “Aerial Lift,” U.S. Pat. No. 3,877,544 by McCollum titled “Stress Balanced Extendible Boom Structure,” and U.S. Pat. No. 2,797,833 by Cash, Jr. titled “Airline Food Loader Truck.” Unfortunately, the operational requirements of some of these devices necessitate extensive boom-type or robotic-type arms that extend outwardly from a base. The present inventor has recognized that the design of these boom-type arms necessitate an apparatus with a much greater height or profile than is permissible for moving beneath the fuselage or wing of an aircraft, where the clearance is rarely more than a few feet above the ground. Moreover, these boom-type arms conventionally carry extensive electronics and can be quite expensive to manufacture. Other problems associated with these boom-type arms and recognized by the inventor of the present application include the risk of damage to the long outwardly extending arms because of the extreme weight of munitions payloads, the requirement of complex and expensive control of the arm at a base a distance away from the aircraft, and the lack of effective control of the arm. Although a few of the prior art bomb lift designs are workable for handling munitions, an enhanced design which overcomes the limitations of the prior art is needed.

### SUMMARY OF THE INVENTION

One embodiment of an aircraft munitions handling apparatus that is used to load munitions onto an aircraft has a plurality of wheel assemblies that are independently driven by drive assemblies. Each of the wheel assemblies is omni-directional which allows the munitions handler to move in any longitudinal, lateral, or diagonal direction for excellent maneuverability. The apparatus includes a munitions support for receiving and supporting a munition, and an elevator that is used to move the munitions support and munition in a vertical direction. In one version, the elevator uses a double-parallelogram, cantilevered arm configuration that folds nearly flat to fit within the apparatus, and can lift straight up above the apparatus. A portion of the arm can rotate forward to place the munitions support in front of the base when remote reach is required. A pivot assembly having four movable cams at the four corners of the munitions support is used as a self-leveling device for unstable conditions, or to pitch and roll the munitions support as needed to attach munitions to an aircraft. In addition, the munitions handler is capable of passing beneath objects having very limited vertical clearances. The munitions handler is designed to receive and transport a wide range of munitions, and also has the ability to turn a circle inside a 10-foot square to precisely position munitions under wing pylons and bomb bays.

In one version of the present invention, the munitions support can include a trough for cradling munitions therein. The trough has open front and rear ends to avoid obstruction of munitions that extend beyond the ends of the trough. An elevator is used to raise and lower the munitions support between a lowered position defined by the munitions support being adjacent to the base, and a raised position defined by the munitions support being elevated above the base. A pivot assembly is used to pivot the munitions support at desired pitch and roll angles relative to the base. In one embodiment, the pivot assembly includes a plurality of cams that are slidably mounted to the elevator.

The present invention also includes methods of handling aircraft munitions, such as loading and/or unloading munitions payloads with respect to an aircraft. For example, the method can include loading a munition onto a munitions support having a longitudinal orientation, transporting the munitions support in a lateral direction that is transverse to the longitudinal orientation, positioning the munitions support in a vertical direction to locate the munition on the munitions support adjacent an aircraft, and offloading the munition from the munitions support to the aircraft. The positioning step, for example, can include moving the munitions support in the horizontal direction while simultaneously raising or lowering the munitions support so that the munition and the munitions support in combination are being horizontally and vertically extended or retracted. This method provides excellent maneuverability for loading a munition onto an aircraft.

### BRIEF DESCRIPTION OF THE DRAWINGS

So that the manner in which the features and advantages of the invention, as well as others which will become apparent, are attained and can be understood in more detail, more particular description of the invention briefly summarized above may be had by reference to the embodiments thereof which are illustrated in the appended drawings, which drawings form a part of this specification. It is to be noted, however, that the drawings illustrate only embodiments of the invention and therefore are not to be considered limiting of its scope as the invention may admit to other equally effective embodiments.

FIG. 1 is an environmental perspective view of one embodiment of an aircraft munitions handling system constructed in accordance with the present invention and shown in operation loading a munition on an aircraft;

FIG. 2 is a perspective view of the aircraft munitions handling system of FIG. 1 illustrating a munitions support thereof partially elevated and without munition positioned therein according to an embodiment of the present invention;

FIG. 3 is a top plan view of the aircraft munitions handling system of FIG. 1 according to an embodiment of the present invention;

FIG. 4 is a side elevational view of the aircraft munitions handling system of FIG. 1 according to an embodiment of the present invention;

FIG. 5 is a fragmentary side elevational view of one end of a pivot assembly of the aircraft munitions handling system of FIG. 1 illustrating various degrees of freedom of movement thereof according to an embodiment of the present invention;

FIG. 6 is a fragmentary side elevational view of the pivot assembly of FIG. 5 illustrating various degrees of freedom of movement thereof according to an embodiment of the present invention;

FIG. 7 is a fragmentary perspective view of the pivot assembly of FIG. 6 illustrating various degrees of freedom of movement thereof according to an embodiment of the present invention;

FIG. 8 is an environmental top plan view of the aircraft munitions handling system of FIG. 1 illustrating various degrees of freedom of movement thereof according to an embodiment of the present invention;

FIG. 9 is an environmental top view of the aircraft munitions handling system of FIG. 1 illustrating additional degrees of freedom of movement thereof according to an embodiment of the present invention;

FIG. 10 is an exploded perspective view of the aircraft munitions handling system of FIG. 1, illustrating various optional equipment that can be used in conjunction therewith according to embodiments of the present invention;

FIG. 11 is an environmental perspective view of an embodiment of an aircraft munitions handling system constructed in accordance with an embodiment of the present invention and shown in operation loading a munition on an aircraft;

FIG. 12 is a perspective view of the aircraft munitions handling system of FIG. 11 illustrating various degrees of freedom of movement of a munitions support thereof according to an embodiment of the present invention;

FIG. 13 is a perspective view of the aircraft munitions handling system of FIG. 11 illustrating a pivot assembly thereof according to an embodiment of the present invention;

FIG. 14 is a top plan view of the aircraft munitions handling system of FIG. 11 according to an embodiment of the present invention;

FIG. 15 is a side elevational view of the aircraft munitions handling system of FIG. 11 according to an embodiment of the present invention;

FIG. 16 is an environmental top plan view of the aircraft munitions handling system of FIG. 11 illustrating various degrees of freedom of movement thereof according to an embodiment of the present invention; and

FIG. 17 is an environmental top view of the aircraft munitions handling system of FIG. 11 illustrating additional degrees of freedom of movement thereof according to an embodiment of the present invention.

### DETAILED DESCRIPTION

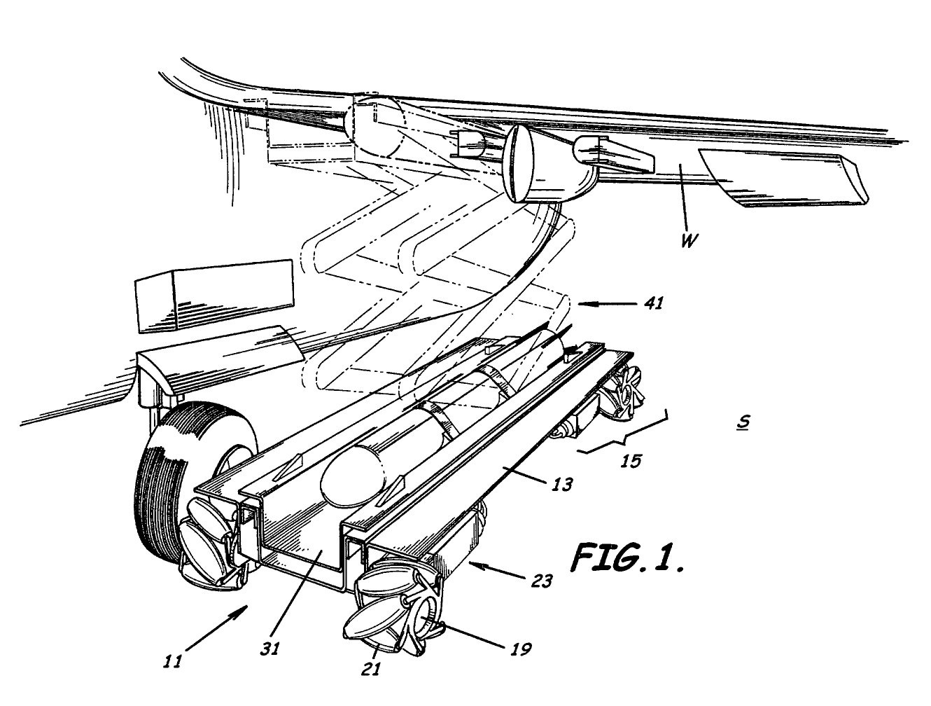

FIGS. 1-10 illustrate a first embodiment of an apparatus 11 for handling aircraft munitions. The apparatus 11 is well suited for different types of munitions handling, such as transporting munitions payloads with very high maneuverability, and loading and unloading weapons payloads with respect to aircraft. For purposes of illustration, the apparatus 11 is shown loading a munition onto the wing W of an aircraft. The apparatus 11 also can be used for loading munitions into a bomb bay located beneath the fuselage of an aircraft, or still other payloads into or onto other locations on an aircraft.

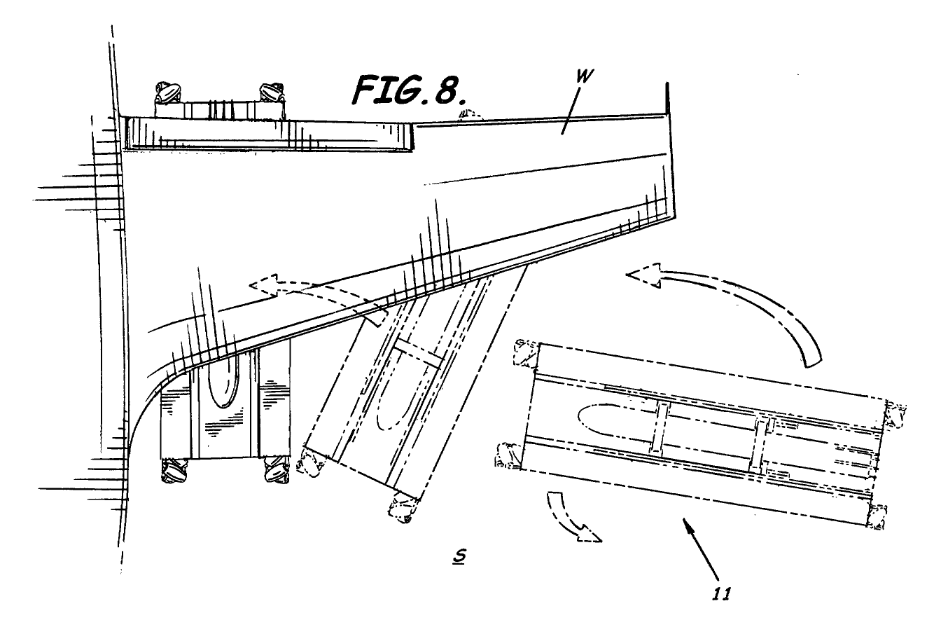

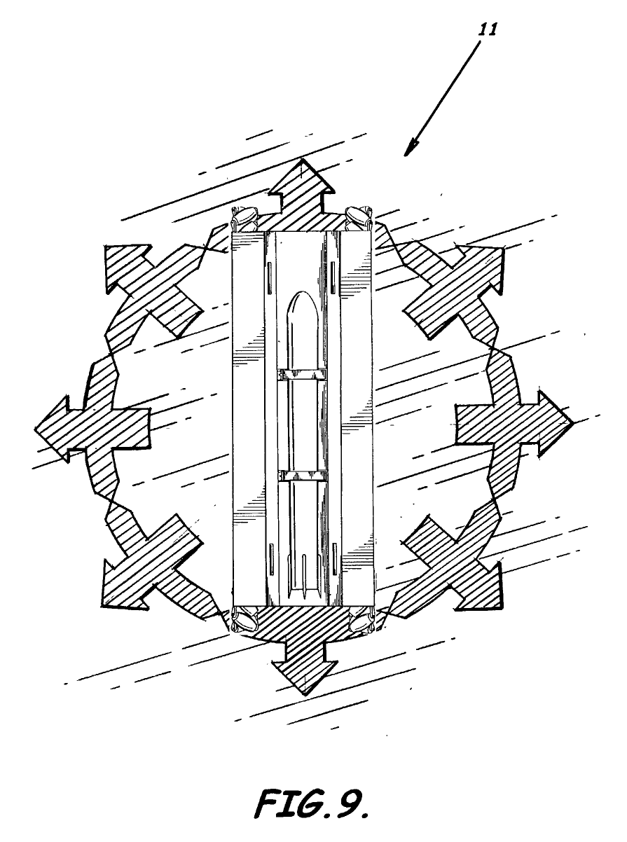

The apparatus 11 includes a base 13 having a plurality of wheel members 15 (four shown) that are positioned to allow the base 13 to travel along surfaces S. Each of the plurality of wheel members 15 of the base 13 includes an independent, multi or omni-directional vehicle wheel 16 for providing at least forward, backward, lateral, diagonal, and rotational movement of the base 13 (see arrows in FIGS. 8 and 9). Each of the wheel members 15 of the base 13 preferably include a hub 19 and a plurality of roller members 21 dispersed around the hub 19. Each of the wheel members 15 is drivable or movable in response to a drive assembly 23 (FIG. 1) in a selected direction independent of each of the other plurality of wheel members 15. The drive assembly 23 can have separate drive elements as shown, or a single integrated drive element as is known by those skilled in the art. Examples of a drive assembly 23 can include engines, motors, and the like.

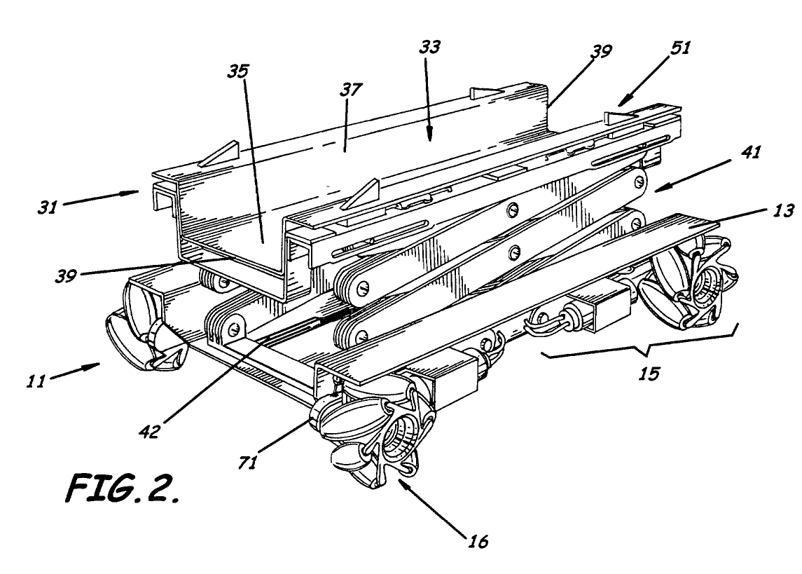

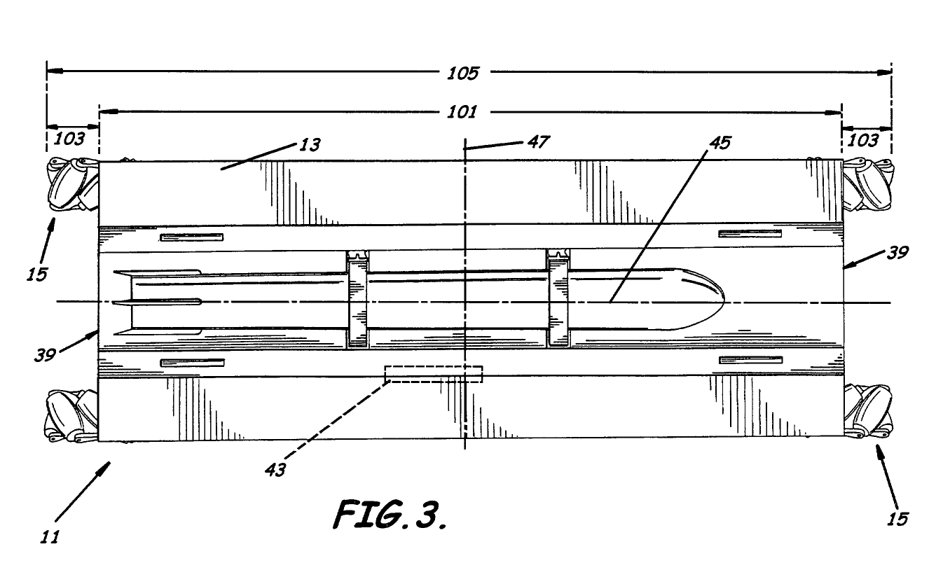

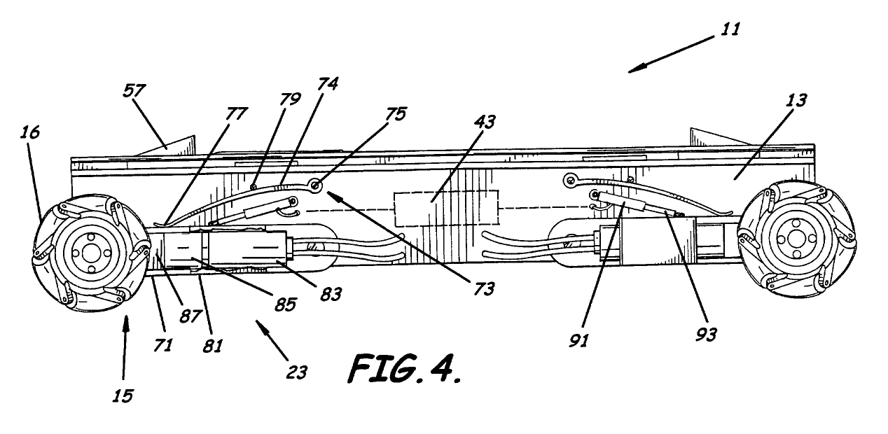

The apparatus 11 also has a munitions support 31 (FIGS. 2 and 7) that is adapted to receive and support munitions thereon. The munitions support 31 can include a trough 33 having a lower support surface 35 and a plurality of side walls 37 extending upward from the lower support surface 35 to cradle munitions in the trough 33. The trough 33 also has substantially open front and rear ends positioned at terminal ends 39 of the lower support surface 35 and the plurality of side walls 37 to avoid obstruction of munitions that extend beyond the terminal ends 39. An elevator 41 is connected to the base 13 and the munitions support 31 to raise and lower the munitions support 31 between a lowered position (FIGS. 1 and 4) defined by the munitions support 31 being adjacent to or within the base 13, and a raised position (FIGS. 1, 2, and 10) defined by the munitions support 31 being elevated above the base 13. In this version, the elevator 41 can include a thin profile scissor-lift assembly that is raised and lowered with a hydraulic system 42 or other means typically employed by those skilled in the art. The apparatus 11 also has a controller 43 (FIGS. 3 and 4) positioned to control the drive assembly 23, the elevator 41, and other features of apparatus 11, such as a pivot assembly 51 and a lifting and shock absorbing system 91 which are described herein below.

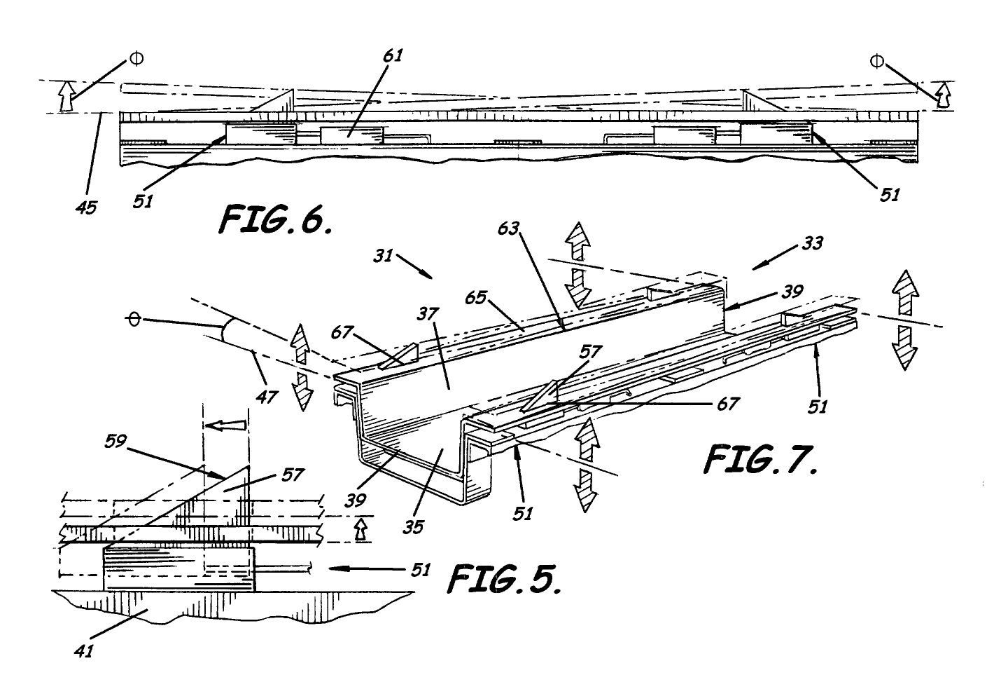

As perhaps best shown in FIG. 3, the base 13 has a longitudinal axis 45 and a lateral axis 47 that is transverse to the longitudinal axis 45. The apparatus 11 also has a pivot assembly 51 (see FIGS. 2 and 5-7) positioned between and connected to the munitions support 31 and an upper end of the elevator 41 to pivot the munitions support 31 at a desired pitch angle φ (FIG. 6) relative to the longitudinal axis 45 of the base 13, and to pivot the munitions support 31 at a desired roll angle θ (FIG. 7) relative to the lateral axis 47 of the base 13. In one version, the pivot assembly 51 can include a plurality of cams or wedges 57 (FIG. 5) having inclined surfaces 59 and being slidably mounted to the elevator 41. A plurality of actuators 61 (FIG. 6) are mounted to the elevator 41 so that actuation of selected ones of the actuators 61 slides associated ones of the wedges 57 to increase and decrease the desired pitch and roll angles φ, θ of the munitions support 31 relative to the base 13.

As shown in FIG. 7, each of the plurality of side walls 37 of the trough 33 has an upper end 63 and a flange 65 extending from each of the upper ends 63 in opposite directions away from the lower support surface 35 to thereby define a pair upper ends 63 and a pair of flanges 65. The pair of flanges 65 is substantially parallel to the lower support surface 35. Each of the pair of flanges 65 has an aperture 67 through which a respective one of the wedges 57 extends. When the actuators 61 slide or move the wedges 57, the inclined surfaces 59 of the wedges 57 slidably engage the flange 65 to pitch and roll the trough 33. The pivot assembly 51, for example, can have two wedges 57 and two actuators 61 associated with each of the pair of flanges 65. Each of the pair of flanges 65 has two apertures 67. The two apertures 67 are positioned adjacent the front and rear ends 39 of the trough 33, respectively, through which respective ones of the wedges 57 extend so that the inclined surfaces 59 of the wedges 57 associated with each flange 65 face in opposite directions.

As shown in FIGS. 2 and 4, each of the plurality of wheel assemblies 15 can have a wheel mount 71 and an omnidirectional wheel member 16 rotatably mounted to the wheel mount 71. The apparatus 11 further can have a plurality of suspensions 73 (FIG. 4) which, in one embodiment of the invention, are each independent. Each of the plurality of suspensions 73 extends between the base 13 and a respective one of the plurality of wheel assemblies 15 so that each of the plurality of suspensions 73 is actuated independently of other ones of the plurality of suspensions 73. Each of the plurality of suspensions 73 can include a leaf spring 74 having a proximal end 75 pivotally mounted to the base 13, a distal end 77 in sliding contact with the wheel mount 71, and a stop pin 79 mounted to the base 13 to limit a range of motion of the distal end 77 of the leaf spring 74, and thereby a pivotal range of motion of the wheel mount 71 in response to deflections of a respective one of the plurality of wheel assemblies 15 as it moves along the surfaces S. Each of the plurality of wheel assemblies 15 is cantilevered relative to the base 13 via a respective one of the wheel mounts 71, and is thereby located outboard of the base 13.

Each of the plurality of wheel mounts 71 also has a wheel channel 81 or a plurality of wheel channels 81. The drive assembly 23 can include a plurality of drive assemblies 23 which, in one embodiment of the invention, are each independent. Each of the plurality of drive assemblies 23 having a drive servo motor 83 (FIG. 4), a gear box 85, and a motor amplifier 87 that are located inside a respective one of the plurality of wheel channels 81. The apparatus 11 further includes a lifting and shock absorbing system 91 having a plurality of piston and cylinder assemblies 93. Each of the piston and cylinder assemblies 93 is connected to and extends between the base 13 and a respective one of the wheel mounts 71 so that the lifting and shock absorbing system 91 selectively raises and lowers the base 13 with respect to the surfaces S and absorbs shock as the apparatus 11 travels over the surfaces S.

As shown in FIG. 3, the base 13 defines a longitudinal direction along the longitudinal axis 45 and has a length 101 measured in the longitudinal direction that substantially aligns with the front and rear ends 39 of the trough 33. At least portions 103 of the wheel assemblies 15 extend beyond the length 101 of the base 13 so that a dimension 105 between the at least portions 103 of the wheel assemblies 15 defines an overall length 105 of the apparatus 11 in the longitudinal direction.

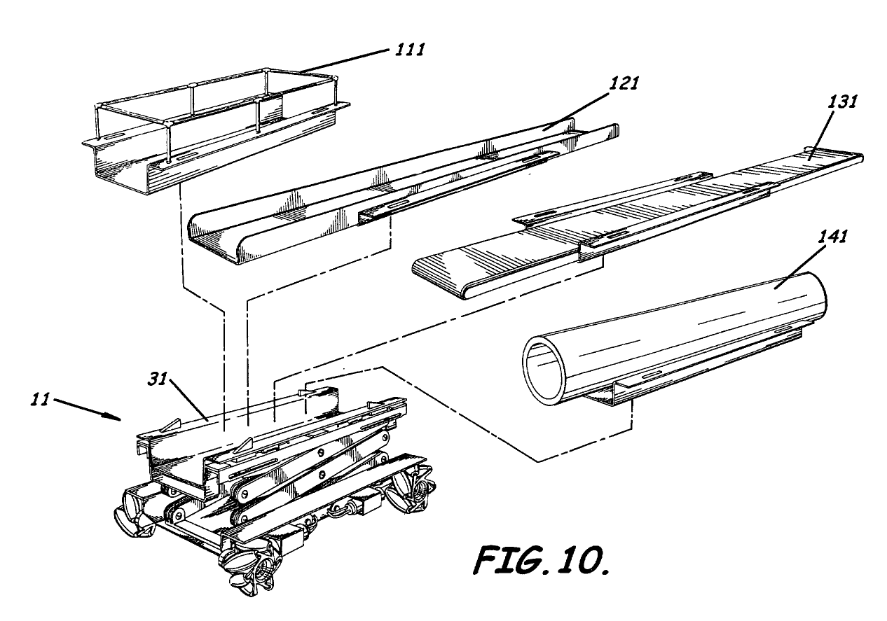

As shown in FIG. 10, the apparatus 11 is capable of serving as a support for a number of different devices and applications of service. For example, the munitions support 31 of the apparatus 11 can be used to support and articulate a frame assembly 111 such as those utilized in scaffolding, a chute assembly 121 such as those utilized in gravity-feed systems, a conveyor belt assembly 131 such as those utilized in conveying goods, or a conduit assembly 141 such as those utilized to channel materials and/or supplies. Each of these assemblies 111, 121, 131, 141, and still other assemblies can be articulated in the same manner previously described for the munitions support 31 as it supports an aircraft munition.

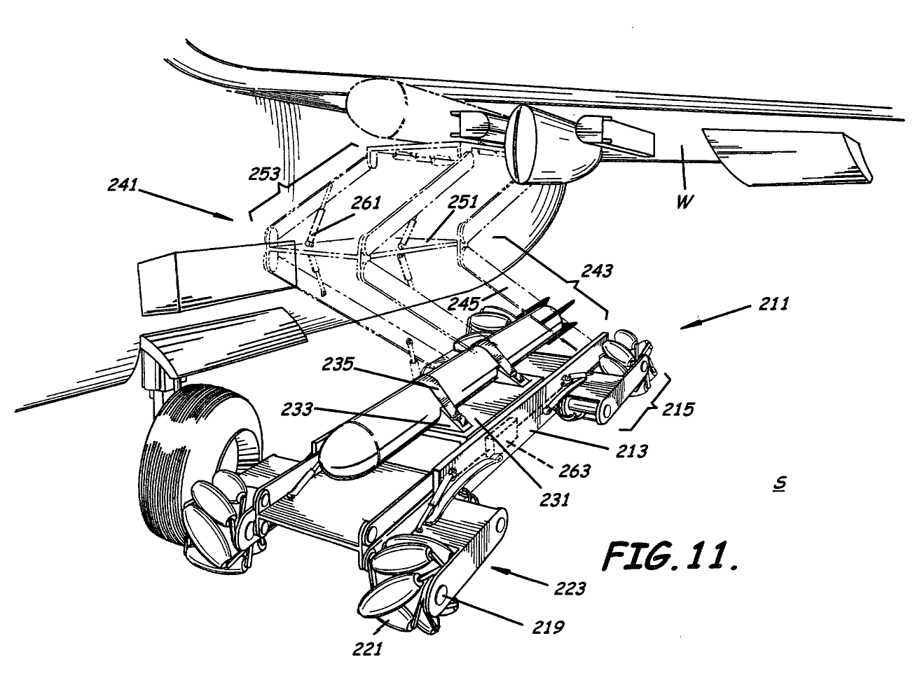

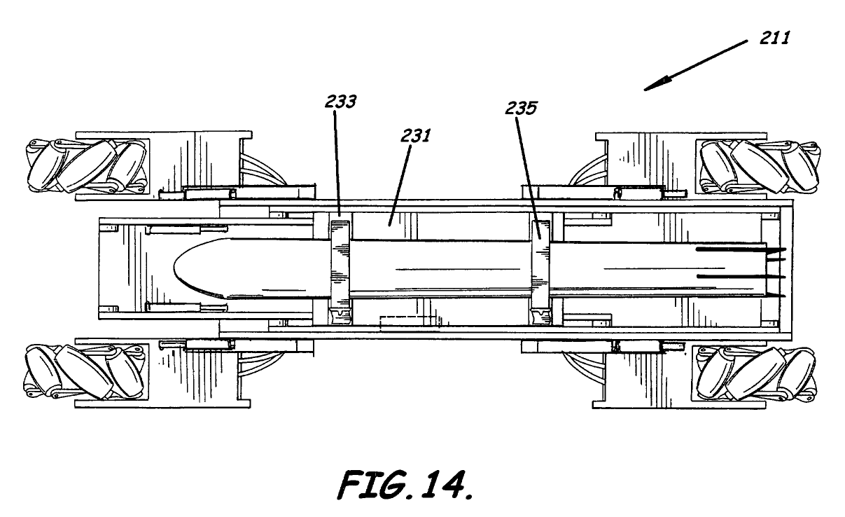

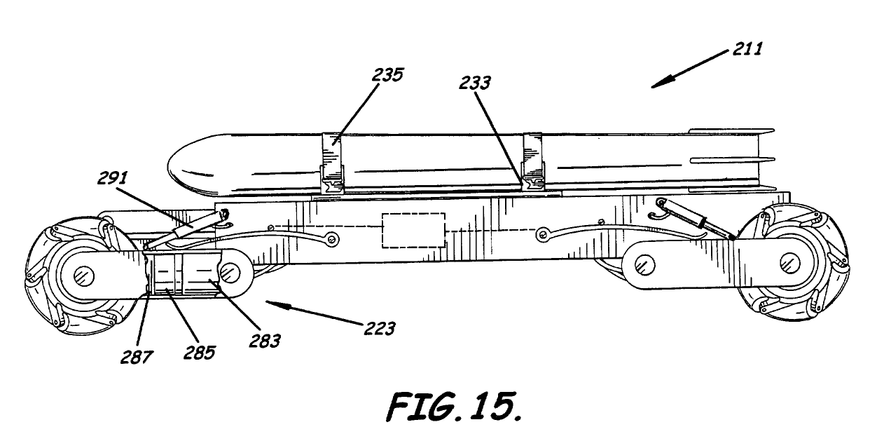

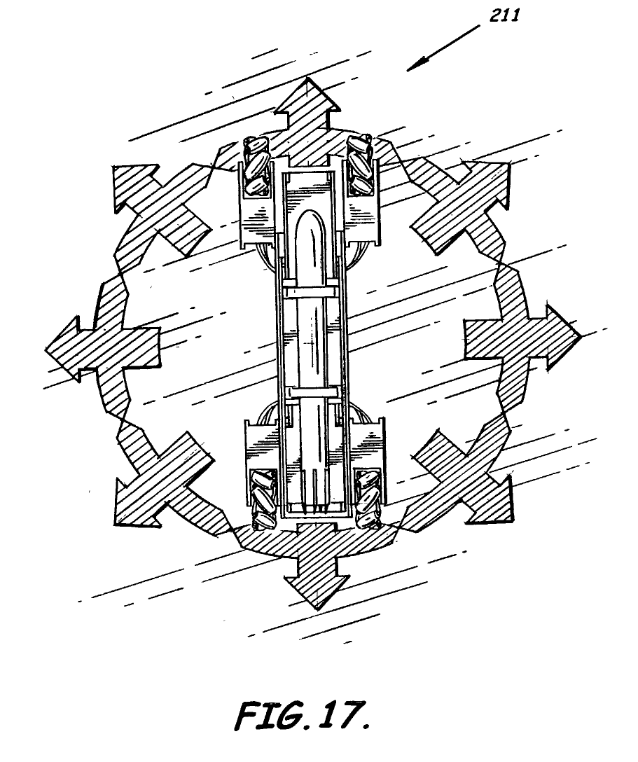

FIGS. 11-17 illustrate a second embodiment of a vehicle or apparatus 211 for handling aircraft munitions. Like the apparatus 11 of the first embodiment, the apparatus 211 is well suited for different types of munitions handling, such as transporting munitions payloads with very high maneuverability, and loading and unloading payloads with respect to aircraft. For purposes of illustration, the apparatus 211 is shown loading a munition onto the wing W of an aircraft. The apparatus 211 includes a base 213 having a plurality of wheel members 215 (four shown) that are positioned to allow the base 213 to travel along surfaces S.

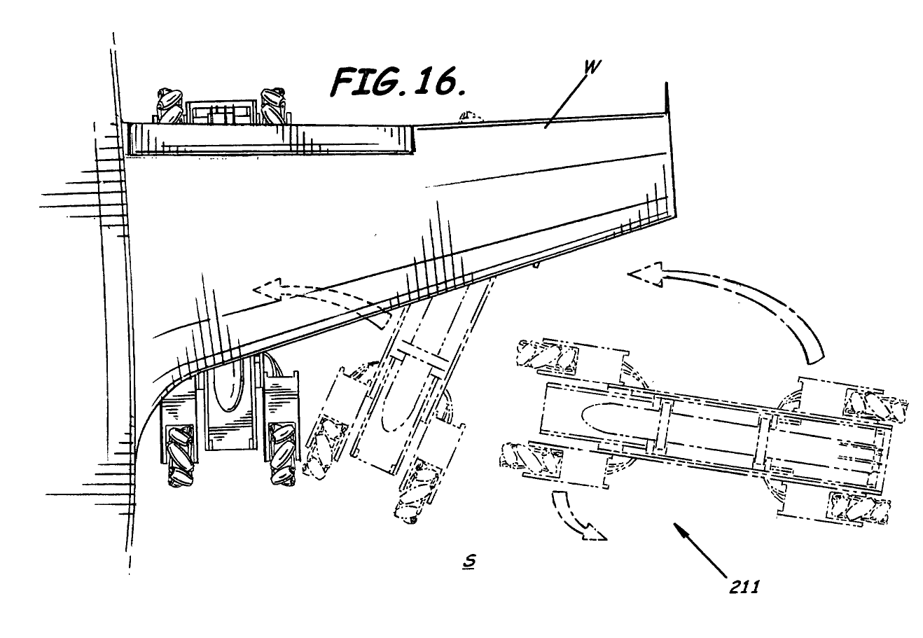

Each of the plurality of wheel members 215 of the base 213 includes an independent, multi or omni-directional vehicle wheel 216 that is substantially identical to wheel 16 described above. The vehicle wheels 216 as shown advantageously provide at least forward, backward, lateral, diagonal, and rotational movement of the base 213 (see arrows in FIGS. 16 & 17). Each of the wheel members 215 of the base 213 preferably include a hub 219 and a plurality of roller members 221 dispersed around the hub 219. Each of the wheel members 215 is drivable or movable in response to a drive assembly 223 (FIG. 11) in a selected direction independent of each of the other plurality of wheel members 215. The drive assembly 223 can have separate drive elements as shown, or a single integrated drive element as is known by those skilled in the art of drive mechanisms. Examples of the drive assembly 223 can include engines, motors, and the like, and can be substantially identical to the drive assembly 23 previously described.

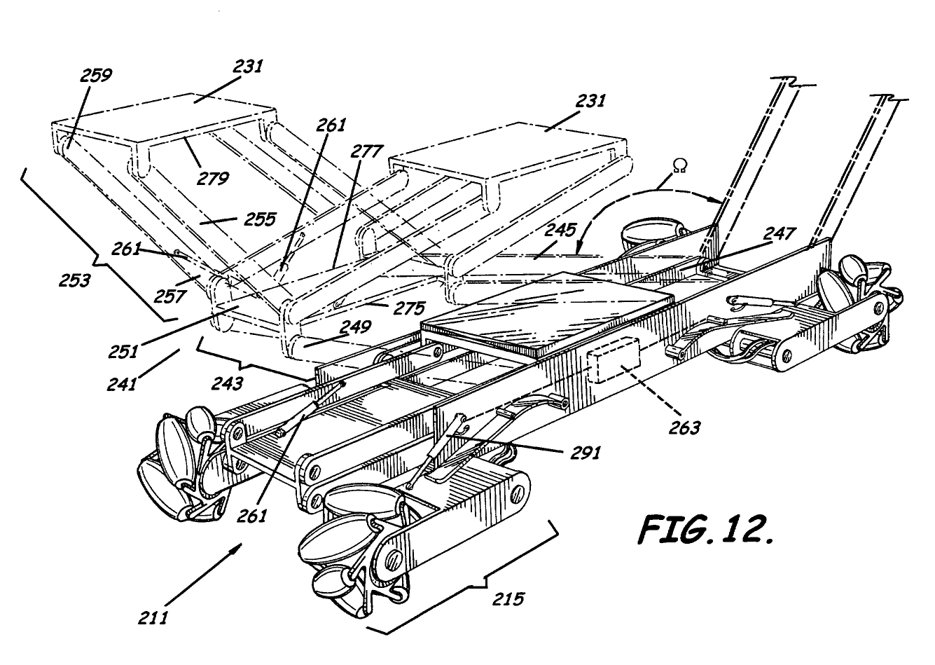

The apparatus 211 can also include a munitions support 231 (FIGS. 11-13) that is adapted to receive and support munitions thereon. The munitions support 231 includes munition stabilizers 233 (FIGS. 11, 14, and 15) and clamps, straps, or other devices 235 for securing a munition to munitions support 231. In the embodiment shown, the munitions support 231 is connected to an elevator 241. As perhaps best shown in FIGS. 11 and 12, the elevator 241 has a primary arm 243 including a plurality of primary linkages 245, each having a proximal portion 247 pivotally mounted to the base 213 and a distal portion 249 spaced apart from the proximal portion 247. The primary arm 243 has a range of pivotal motion from a retracted position (FIGS. 11-13 and 15) that is adjacent and substantially parallel to the base 213 to an extended position (FIGS. 11 and 12) that extends away from and defines an obtuse angle Q (FIG. 12) with respect to the base 213. An intermediate bracket 251 is pivotally mounted to the distal portions 249 of the primary linkages 245.

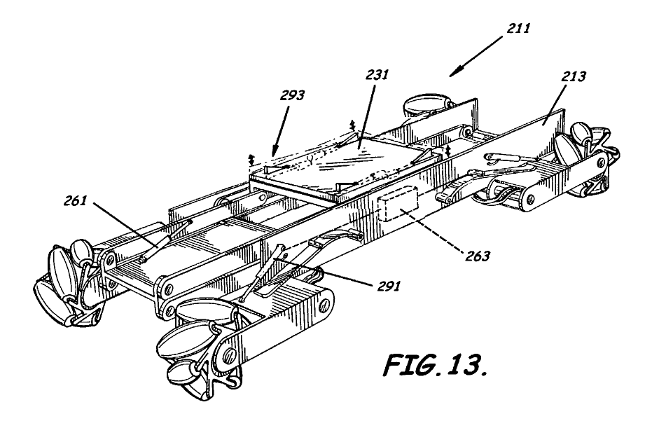

The elevator 241 also has a secondary arm 253 including a plurality of secondary linkages 255, each having a proximal portion 257 pivotally mounted to the intermediate bracket 251 and a distal portion 259 spaced apart from the intermediate bracket 251. The secondary arm 253 has a range of pivotal motion (see FIG. 12) from a retracted position that is adjacent and substantially parallel to the primary arm 243 to an extended position that extends away from and defines an obtuse angle with respect to the primary arm 243. The munitions support 231 is connected to the distal portions 259 of the plurality of secondary linkages 255 and adapted to receive munitions thereon. The elevator 241 includes an elevating apparatus 261 (FIGS. 12 and 13), such as a hydraulic system, connected to the base 213 for raising and lowering the munitions support 231 via the primary and secondary arms 243, 253 between a lowered position defined by the munitions support 231 being adjacent the base 213, and a raised position defined by the munitions support 231 being elevated above the base 213. The apparatus 211 is also provided with suspensions 273, which can be identical to the suspensions 73 described above if desired. In addition, the apparatus 211 has a lifting and shock absorbing system 291 (FIGS. 12, 13, and 15) that can be identical to the earlier described lifting and shock absorbing system 91. Furthermore, the apparatus 211 can be provided with a pivot assembly 293 (FIG. 13) that can be identical to the pivot assembly 51 described above. A controller 263 (FIGS. 11-13) is positioned to control the drive assembly 223, the elevator 241, the elevating apparatus 261, and other features of apparatus 211 that also can be employed such as the pivot assembly 293, and the lifting and shock absorbing system 291.

The intermediate bracket 251 includes a plate having a primary surface 275 connected to each of the distal portions 249 of the primary linkages 245, and a secondary surface 277 connected to each of the proximal portions 257 of the secondary linkages 255. In this version, the munitions support 231 includes a plate having a surface 279 connected to each of the distal portions 259 of the secondary linkages 255. In one version, the primary linkages 245 are parallel to each other throughout the range of pivotal motion of the primary arm 243, and the secondary linkages 255 are parallel to each other throughout the range of pivotal motion of the secondary arm 253. As shown in FIG. 12, in the raised position, the munitions support 231 is located directly over the surfaces S supporting the base 213 so that the apparatus 211 can be located away from a location on an aircraft to which munitions are being attached.

In operation, apparatus 11 and apparatus 211 each provide a method of handling aircraft munitions, such as loading and/or unloading munitions payloads with respect to an aircraft. For example, as shown in FIG. 1, the method can include loading a munition onto a munitions support 31 having a longitudinal orientation, transporting the munitions support 31 in a lateral direction that is transverse to the longitudinal orientation, positioning the munitions support 31 in a vertical direction to locate the munition on the munitions support 31 adjacent an aircraft, and offloading the munition from the munitions support 31 to the aircraft. The positioning step, for example, can include moving the munitions support 31 in the horizontal direction while simultaneously raising or lowering the munitions support 31 so that the munition and the munitions support 31 in combination are being horizontally and vertically extended or retracted. In addition, the method can include a step of changing a pitch angle and a roll angle of the munitions support 31 so that the munition support 31 is pivoted with respect to the longitudinal orientation and the lateral direction, respectively. Each of the devices used to drive, rotate, elevate, and pivot the various elements of the invention can include motors, hydraulic actuators, pneumatic systems, or any other device that one skilled in the art can choose for such an application.

As shown in FIG. 11, the present invention also provides a method of handling aircraft munitions, including loading a munition onto a munitions support 231 having a base and a longitudinal orientation, transporting the munition and the munitions support 231 on a support surface in any horizontal direction including movement directly in a lateral direction that is transverse to the longitudinal orientation, positioning the munitions support 231 in a vertical direction to locate the munition loaded thereon adjacent an aircraft, changing a pitch angle and a roll angle of the munitions support 231 with respect to the base, and offloading the munition from the munitions support 231 to the aircraft. In this method, the positioning step can further include moving the munitions support 231 in the horizontal direction while simultaneously raising or lowering the munitions support 231 so that the munitions support 231 is being horizontally and vertically extended or retracted, and the munitions support 231 is located directly over the support surface.

The present invention has many advantages. The plurality of wheel assemblies are independently driven and are omni-directional to allow the munitions handling apparatus or munitions handler to move in any longitudinal, lateral, or diagonal direction for excellent maneuverability. In one version, the elevator uses a double-parallelogram, cantilevered arm configuration that folds nearly flat to fit within the base's profile, can lift straight up above the base, or the secondary arm can rotate forward to place the munitions support to the front of the base when remote reach is required. The primary arm is lower and longer than the secondary arm, but both arms have a range of travel of approximately 180 degrees. The pivot assembly has four movable wedges at the four corners of the munitions support that are used as a self-leveling device for unstable conditions, or to pitch and roll the munitions support as needed to attach munitions to an aircraft. In addition, such as shown in FIG. 10, many different types of attachments, such as frameworks, chutes, conveyors, and conduits, can be coupled to the munitions handler to enable the munitions handler to be a multi-functional vehicle.

More specifically, the munitions handler is capable of passing beneath objects such as aircraft having less than three feet of vertical clearance. The munitions handler is designed to receive and transport a wide range of munitions having weights up to approximately 6000 pounds. The munitions handler also has the ability to turn 360-degrees inside a ten-foot diameter to quickly and precisely position munitions under wing pylons and bomb bays. In addition, the munitions handler has the ability to transition from a truck ramp onto pavement with ease.

Although the invention has been shown or described in only some of its forms, it should be apparent to those skilled in the art that it is not so limited, but is susceptible to various changes without departing from the scope of the invention.

That claimed is:

1. An apparatus for handling munitions, the apparatus comprising:
a base;
a plurality of wheel assemblies connected to the base and positioned to allow the base to travel along surfaces;
a drive assembly connected to the base and positioned to drive the plurality of wheel assemblies;
a munitions support adapted to receive and support munitions thereon, the munitions support comprising a trough having a lower support surface and a plurality of side walls extending upward from the lower support surface to cradle munitions in the trough, the trough also having substantially open front and rear ends positioned at terminal ends of the lower support surface and the plurality of side walls to avoid obstruction of munitions that extend beyond the terminal ends;
an elevator connected to the base and the munitions support to raise and lower the munitions support between a lowered position defined by the munitions support being adjacent the base and a raised position defined by the munitions support being elevated above the base; and
a controller positioned to control the drive assembly and the elevator.

2. The apparatus of claim 1, wherein the base has a longitudinal axis and a lateral axis that is transverse to the longitudinal axis, and wherein the apparatus further comprises a pivot assembly positioned between and connected to the munitions support and the elevator to pivot the munitions support at a desired pitch angle relative to the longitudinal axis of the base, and to pivot the munitions support at a desired roll angle relative to the lateral axis of the base.

3. The apparatus of claim 2, wherein the pivot assembly comprises a plurality of wedges having inclined surfaces and being slidably mounted to the elevator, and a plurality of actuators mounted to the elevator so that actuation of selected ones of the actuators slides associated ones of the wedges to increase and decrease the desired pitch and roll angles of the munitions support relative to the base.

4. The apparatus of claim 3, wherein each of the plurality of side walls of the trough has an upper end and a flange extending from each of the upper ends in opposite directions away from the lower support surface to thereby define a pair upper ends and a pair of flanges so that the pair of flanges is substantially parallel to the lower support surface, and wherein each of the pair of flanges has an aperture through which a respective one of the wedges extends so that when the actuators slide the wedges, the inclined surfaces of the wedges slidably engage the flange to pitch and roll the trough.

5. The apparatus of claim 4, wherein the pivot assembly comprises two wedges and two actuators associated with each of the pair of flanges, and wherein each of the pair of flanges has two apertures, the two apertures being positioned adjacent the front and rear ends of the trough, respectively, through which respective ones of the wedges extend so that the inclined surfaces of the wedges associated with each flange face in opposite directions.

6. The apparatus of claim 1, wherein each of the plurality of wheel assemblies comprises a wheel mount and an omnidirectional wheel member rotatably mounted to the wheel mount, and wherein the apparatus further comprises a plurality of suspensions, each of which extends between the base and a respective one of the plurality of wheel assemblies so that each of the plurality of suspensions is actuated independently of other ones of the plurality of suspensions.

7. The apparatus of claim 6, wherein each of the plurality of suspensions comprises a leaf spring having a proximal end pivotally mounted to the base, a distal end in sliding contact with the wheel mount, and a stop pin mounted to the base to limit a range of motion of the distal end of the leaf spring and thereby a pivotal range of motion of the wheel mount in response to deflections of a respective one of the plurality of wheel assemblies as it moves along the surfaces.

8. The apparatus of claim 1, wherein, in the raised position, the munitions support is located directly over the surfaces supporting the base so that the apparatus can be located away from a location on an aircraft to which munitions are being attached.

9. The apparatus of claim 1, wherein each of the plurality of wheel assemblies further comprises a wheel mount to define a plurality of wheel mounts, each of the plurality of wheel mounts being connected to the base such that each of the plurality of wheel assemblies is cantilevered relative to the base via a respective one of the wheel mounts, and is thereby located outboard of the base.

10. The apparatus of claim 9, wherein each of the plurality of wheel mounts comprises a wheel channel to define a plurality of wheel channels, and wherein the drive assembly comprises a plurality of drive assemblies, each of the plurality of drive assemblies having a drive servo motor, a gear box, and a motor amplifier that are located inside a respective one of the plurality of wheel channels.

11. The apparatus of claim 9, further comprising a lifting and shock absorbing system having a plurality of piston and cylinder assemblies, each connected to and extending between the base and a respective one of the wheel mounts so that the lifting and shock absorbing system selectively raises and lowers the base with respect to the surfaces and absorbs shock as the apparatus travels over the surfaces.

12. The apparatus of claim 1, wherein the base defines a longitudinal direction and has a length measured in the longitudinal direction that substantially aligns with the front and rear ends of the trough, and at least portions of the wheel assemblies extend beyond the length of the base so that a dimension between said at least portions of the wheel assemblies defines an overall length of the apparatus in the longitudinal direction.

13. The apparatus of claim 1, wherein the elevator comprises:
a primary arm comprising at least one primary linkage having a proximal portion pivotally mounted to the base and a distal portion spaced apart from the proximal portion, the primary arm having a range of pivotal motion from a retracted position that is substantially parallel to and located within the base, to an extended position that extends away from and defines an obtuse angle with respect to the base;
an intermediate bracket pivotally mounted to the distal portion of said at least one primary linkage; and
a secondary arm comprising at least one secondary linkage having a proximal portion pivotally mounted to the intermediate bracket and a distal portion spaced apart from the intermediate bracket, the secondary arm having a range of pivotal motion from a retracted position that is adjacent and substantially parallel to the primary arm, to an extended position that extends away from and defines an obtuse angle with respect to the primary arm.

14. An apparatus for handling munitions, the apparatus comprising:
a base;
a plurality of wheel assemblies connected to the base and positioned to allow the base to travel along surfaces, each having a wheel mount pivotally mounted to the base and an omnidirectional wheel member rotatably mounted to the wheel mount so that each of the plurality of wheel assemblies is cantilevered relative to the base via the wheel mount and is thereby located outboard of the base;
a plurality of independent drive assemblies, each connected to a respective one of the plurality of wheel assemblies to independently drive the plurality of wheel assemblies;
a munitions support adapted to receive munitions thereon;
an elevator connected to the base and the munitions support to raise and lower the munitions support between a lowered position defined by the munitions support being adjacent the base, and a raised position defined by the munitions support being elevated above the base; and
a controller positioned to control each of the plurality of independent drive assemblies and the elevator so that the controller manipulates the munitions support via the plurality of wheel assemblies and the elevator.

15. The apparatus of claim 14, further comprising a plurality of suspensions, each connected to and extending between the base and a respective one of the plurality of wheel assemblies so that each of the plurality of suspensions is actuated independently of other ones of the plurality of suspensions, and wherein each of the plurality of suspensions comprises a leaf spring having a proximal end pivotally mounted to the base, a distal end in sliding contact with the wheel mount, and a stop pin mounted to the base to limit a range of motion of the distal end of the leaf spring and thereby a pivotal range of motion of the wheel mount in response to deflections of a respective one of the plurality of wheel assemblies as it moves along the surfaces.

16. The apparatus of claim 14, wherein the munitions support comprises a trough having a lower support surface and a plurality of side walls extending upward from the lower support surface to cradle munitions in the trough, the trough also having substantially open front and rear ends positioned at terminal ends of the lower support surface and the plurality of side walls to avoid obstruction of munitions that extend beyond the terminal ends.

17. The apparatus of claim 14, wherein, in the raised position, the munitions support is located directly over the surfaces supporting the base so that the apparatus can be located away from a location on an aircraft to which munitions are being attached.

18. The apparatus of claim 14, wherein each of the wheel mounts comprises a wheel channel to define a plurality of wheel channels, and wherein the drive assembly comprises a plurality of separate drive assemblies, each of the plurality of drive assemblies having a drive servo motor, a gear box, and a motor amplifier that are located inside a respective one of the plurality of wheel channels.

19. The apparatus of claim 14, further comprising a lifting and shock absorbing system having a plurality of piston and cylinder assemblies, each connected to and extending between the base and a respective one of the wheel mounts so that the lifting and shock absorbing system selectively raises and lowers the base with respect to the surfaces, and absorbs shock as the apparatus travels over the surfaces.

20. The apparatus of claim 14, wherein the base defines a longitudinal direction and has a length measured in the longitudinal direction, and wherein at least portions of the wheel assemblies extend beyond the length of the base so that a dimension between said at least portions of the wheel assemblies defines an overall length of the apparatus in the longitudinal direction.

21. The apparatus of claim 14, wherein the base has a longitudinal axis and a lateral axis that is transverse to the longitudinal axis, and wherein the apparatus further comprises a pivot assembly positioned between and connected to the munitions support and the elevator to pivot the munitions support at a desired pitch angle relative to the longitudinal axis of the base and to pivot the munitions support at a desired roll angle relative to the lateral axis of the base.

22. The apparatus of claim 21, wherein the pivot assembly comprises a plurality of wedges having inclined surfaces and being slidably mounted to the elevator, and a plurality of actuators mounted to the elevator, so that actuation of selected ones of the actuators slides associated ones of the wedges to increase and decrease the desired pitch and roll angles of the munitions support relative to the base.

23. The apparatus of claim 14, wherein the elevator comprises:
a primary arm comprising at least one primary linkage having a proximal portion pivotally mounted to the base and a distal portion spaced apart from the proximal portion, the primary arm having a range of pivotal motion from a retracted position that is substantially parallel to and located within the base, to an extended position that extends away from and defines an obtuse angle with respect to the base;
an intermediate bracket pivotally mounted to the distal portion of said at least one primary linkage; and
a secondary arm comprising at least one secondary linkage having a proximal portion pivotally mounted to the intermediate bracket and a distal portion spaced apart from the intermediate bracket, the secondary arm having a range of pivotal motion from a retracted position that is adjacent and substantially parallel to the primary arm, to an extended position that extends away from and defines an obtuse angle with respect to the primary arm.

24. An apparatus for handling munitions, the apparatus comprising:
a base having a longitudinal axis and a lateral axis that is transverse to the longitudinal axis;
a plurality of wheel assemblies connected to the base and positioned to allow the base to travel along surfaces;
driving means connected to the base for driving the plurality of wheel assemblies;
supporting means for receiving and supporting munitions thereon;
elevating means connected to the base and the supporting means for raising and lowering the supporting means between a lowered position wherein the supporting means is positioned within the base, and a raised position wherein the supporting means is elevated above the base;
pivoting means connected to the supporting means and the elevating means to pivot the supporting means at a desired pitch angle relative to the longitudinal axis of the base and to pivot the supporting means at a desired roll angle relative to the lateral axis of the base; and
a controller positioned to control the driving means, the elevating means, and the pivoting means, such that the controller manipulates a position of the supporting means relative to an aircraft via the wheel assemblies, the elevating means, and the pivoting means.

25. The apparatus of claim 24, wherein each of the plurality of wheel assemblies comprises a wheel mount and an omnidirectional wheel member rotatably mounted to the wheel mount, and wherein the apparatus further comprises a plurality of suspensions, each of which extends between the base and a respective one of the plurality of wheel assemblies so that each of the plurality of suspensions is actuated independently of other ones of the plurality of suspensions.

26. The apparatus of claim 25, wherein each of the plurality of suspensions comprises a leaf spring having a proximal end pivotally mounted to the base, a distal end in sliding contact with the wheel mount, and a stop pin mounted to the base to limit a range of motion of the distal end of the leaf spring and thereby a pivotal range of motion of the wheel mount in response to deflections of a respective one of the plurality of wheel assemblies as it moves along the surfaces.

27. The apparatus of claim 24, wherein the supporting means comprises a trough having a lower support surface and the plurality of side walls extending upward from the lower support surface to cradle munitions in the trough, the trough also having open front and rear ends positioned at terminal ends of the lower support surface and the plurality of side walls to avoid obstruction of munitions that extend beyond the terminal ends.

28. The apparatus of claim 24, wherein, in the raised position, the supporting means is located directly over the surfaces supporting the base so that the apparatus can be located away from a location on an aircraft to which munitions are being attached.

29. The apparatus of claim 24, wherein each of the plurality of wheel assemblies further comprises a wheel mount to define a plurality of wheel mounts, each of the plurality of wheel mounts being connected to the base such that each of the plurality of wheel assemblies is cantilevered relative to the base via a respective one of the wheel mounts and is thereby located outboard of the base.

30. The apparatus of claim 29, wherein each of the plurality of wheel mounts comprises a wheel channel to define a plurality of wheel channels, and wherein the driving means comprises a plurality of drive assemblies, each of the plurality of drive assemblies having a drive servo motor, a gear box, and a motor amplifier that are located inside a respective one of the plurality of wheel channels.

31. The apparatus of claim 29, further comprising a lifting and shock absorbing system having a plurality of piston and cylinder assemblies, each connected to and extending between the base and a respective one of the wheel mounts, such that the lifting and shock absorbing system selectively raises and lowers the base with respect to the surfaces and absorbs shock as the apparatus travels over the surfaces.

32. The apparatus of claim 24, wherein the base defines a longitudinal direction and has a length measured in the longitudinal direction, and wherein at least portions of the wheel assemblies extend beyond the length of the base so that a dimension between said at least portions of the wheel assemblies defines an overall length of the apparatus in the longitudinal direction.

33. The apparatus of claim 24, wherein the pivoting means comprises a plurality of wedges having inclined surfaces and being slidably mounted to the elevating means, and a plurality of actuators mounted to the elevating means, so that actuation of selected ones of the actuators slide associated ones of the wedges to increase and decrease the desired pitch and roll angles of the supporting means relative to the base.

34. The apparatus of claim 24, wherein the elevating means comprises:
a primary arm comprising at least one primary linkage having a proximal portion pivotally mounted to the base and a distal portion spaced apart from the proximal portion, the primary arm having a range of pivotal motion from a retracted position that is substantially parallel to and located within the base, to an extended position that extends away from and defines an obtuse angle with respect to the base;
an intermediate bracket pivotally mounted to the distal portion of said at least one primary linkage; and
a secondary arm comprising at least one secondary linkage having a proximal portion pivotally mounted to the intermediate bracket and a distal portion spaced apart from the intermediate bracket, the secondary arm having a range of pivotal motion from a retracted position that is adjacent and substantially parallel to the primary arm, to an extended position that extends away from and defines an obtuse angle with respect to the primary arm.

35. An apparatus for handling munitions, the apparatus comprising:
a base;
a plurality of wheel assemblies connected to the base and positioned to allow the base to travel along surfaces;
a drive assembly connected to the base and positioned to drive the plurality of wheel assemblies;
a primary arm comprising a plurality of primary linkages, each having a proximal portion pivotally mounted to the base and a distal portion spaced apart from the proximal portion, the primary arm having a range of pivotal motion from a retracted position that is adjacent and substantially parallel to the base, to an extended position that extends away from and defines an obtuse angle with respect to the base;
an intermediate bracket pivotally mounted to the distal portions of the primary linkages;
a secondary arm comprising a plurality of secondary linkages, each having a proximal portion pivotally mounted to the intermediate bracket and a distal portion spaced apart from the intermediate bracket, the secondary arm having a range of pivotal motion from a retracted position that is adjacent and substantially parallel to the primary arm, to an extended position that extends away from and defines an obtuse angle with respect to the primary arm;
a munitions support connected to the distal portions of the plurality of secondary linkages and adapted to receive munitions thereon;
elevating means connected to the base for raising and lowering the munitions support via the primary and secondary arms between a lowered position defined by the munitions support being adjacent the base and a raised position defined by the munitions support being elevated above the base; and
a controller positioned to control the drive assembly and the elevating means.

36. The apparatus of claim 35, wherein each of the plurality of wheel assemblies comprises a wheel mount and an omnidirectional wheel member rotatably mounted to the wheel mount, and wherein the apparatus further comprises a plurality of suspensions, each of which extends between the base and a respective one of the plurality of wheel assemblies such that each of the plurality of suspensions is actuated independently of other ones of the plurality of suspensions.

37. The apparatus of claim 36, wherein each of the plurality of suspensions comprises a leaf spring having a proximal end pivotally mounted to the base, a distal end in sliding contact with the wheel mount, and a stop pin mounted to the base to limit a range of motion of the distal end of the leaf spring and thereby a pivotal range of motion of the wheel mount in response to deflections of a respective one of the plurality of wheel assemblies as it moves along the surfaces.

38. The apparatus of claim 35, wherein the intermediate bracket comprises a plate having a primary surface connected to each of the distal portions of the primary linkages and a secondary surface connected to each of the proximal portions of the secondary linkages, and wherein the munitions support comprises a plate having a surface connected to each of the distal portions of the secondary linkages.

39. The apparatus of claim 35, wherein the primary linkages are parallel to each other throughout the range of pivotal motion of the primary arm, and wherein the secondary linkages are parallel to each other throughout the range of pivotal motion of the secondary arm.

40. The apparatus of claim 35, wherein, in the raised position, the munitions support is located directly over the surfaces supporting the base so that the apparatus can be located away from a location on an aircraft to which munitions are being attached.

41. The apparatus of claim 35, wherein each of the plurality of wheel assemblies further comprises a wheel mount to define a plurality of wheel mounts, each of the plurality of wheel mounts being connected to the base so that each of the plurality of wheel assemblies is cantilevered relative to the base via a respective one of the wheel mounts, and is thereby located outboard of the base.

42. The apparatus of claim 41, wherein each of the plurality of wheel mounts comprises a wheel channel to define a plurality of wheel channels, and wherein the drive assembly comprises a plurality of drive assemblies, each of the plurality of drive assemblies having a drive servo motor, a gear box, and a motor amplifier that are located inside a respective one of the plurality of wheel channels.

43. The apparatus of claim 41, further comprising a lifting and shock absorbing system having a plurality of piston and cylinder assemblies, each connected to and extending between the base and a respective one of the wheel mounts so that the lifting and shock absorbing system selectively raises and lowers the base with respect to the surfaces, and absorbs shock as the apparatus travels over the surfaces.

44. The apparatus of claim 35, wherein the base defines a longitudinal direction and has a length measured in the longitudinal direction, and at least portions of the wheel assemblies extend beyond the length of the base, such that a dimension between said at least portions of the wheel assemblies defines an overall length of the apparatus in the longitudinal direction.

45. The apparatus of claim 35, wherein the base has a longitudinal axis and a lateral axis that is transverse to the longitudinal axis, and wherein the apparatus further comprises a pivot assembly connected to the munitions support to pivot the munitions support at a desired pitch angle relative to the longitudinal axis of the base and to pivot the munitions support at a desired roll angle relative to the lateral axis of the base.

46. The apparatus of claim 45, wherein the pivot assembly comprises a plurality of wedges and a plurality of actuators so that actuation of selected ones of the actuators slides associated ones of the wedges to engage the munitions support and increase and decrease the desired pitch and roll angles of the munitions support relative to the base.

47. A method of handling aircraft munitions, comprising:
loading a munition onto a munitions support having a longitudinal orientation;
transporting the munitions support in a lateral direction that is transverse to the longitudinal orientation;
positioning the munitions support in a vertical direction to locate the munition on the munitions support adjacent an aircraft; and
offloading the munition from the munitions support to the aircraft.

48. The method of claim 47, wherein the positioning step further comprises moving the munitions support in the horizontal direction while simultaneously raising or lowering the munitions support so that the munition and the munitions support in combination are being horizontally and vertically extended or retracted.

49. The method of claim 47, further comprising the step of changing a pitch angle and a roll angle of the munitions support so that the munition support is pivoted with respect to the longitudinal orientation and the lateral direction, respectively.

50. A method of handling aircraft munitions, comprising:
loading a munition onto a munitions support having a base and a longitudinal orientation;
transporting the munition and the munitions support on a support surface in any horizontal direction including movement directly in a lateral direction that is transverse to the longitudinal orientation;
positioning the munitions support in a vertical direction to locate the munition loaded thereon adjacent an aircraft;
changing a pitch angle and a roll angle of the munitions support with respect to the base;
offloading the munition from the munitions support to the aircraft.

51. The method of claim 50, wherein the positioning step further comprises moving the munitions support in the horizontal direction while simultaneously raising or lowering the munitions support so that the munitions support is being horizontally and vertically extended or retracted, and the munitions support is located directly over the support surface.
